(19) United States
(12) Patent Application Publication
(10) Pub. No.: US 2012/0073481 A1
(43) Pub. Date: Mar. 29, 2012

(54) Mouse and wrist pad glider

(76) Inventor: Vivian Lee Scott, Cincinnati, OH (US)

(21) Appl. No.: 13/200,655

(22) Filed: Sep. 27, 2011

Related U.S. Application Data
(60) Provisional application No. 61/404,113, filed on Sep. 28, 2010.

(51) Int. Cl. G06F 3/039

(52) U.S. Cl. 108/185

(57) ABSTRACT

A mouse pad and wrist rest support designed to reduce (RMI) repetitive motion injury risks by connecting a computer mouse and wrist rest together as one ergonomic moveable unit that provides continuous wrist support and alignment and freedom of movement while eliminating stress on the hand, and median nerve while using a computer mouse.

### CROSS-REFERENCE TO RELATED APPLICATION

I claim the benefit of first to invent, produce, manufacture, and sell the Mouse and Wrist Pad Glider.

Provisional application No: 61/404,113

Provisional application filed: Sep. 28, 2010

Relationship: Non-provisional utility patent application

Design has changed to make it more mouse universal and wrist rest specific.

### STATEMENT REGARDING FEDERALLY SPONSORED RESEARCH / DEVELOPMENT

Not applicable

### REFERENCE TO SEQUENCE LISTING

Not applicable

PRIOR ART

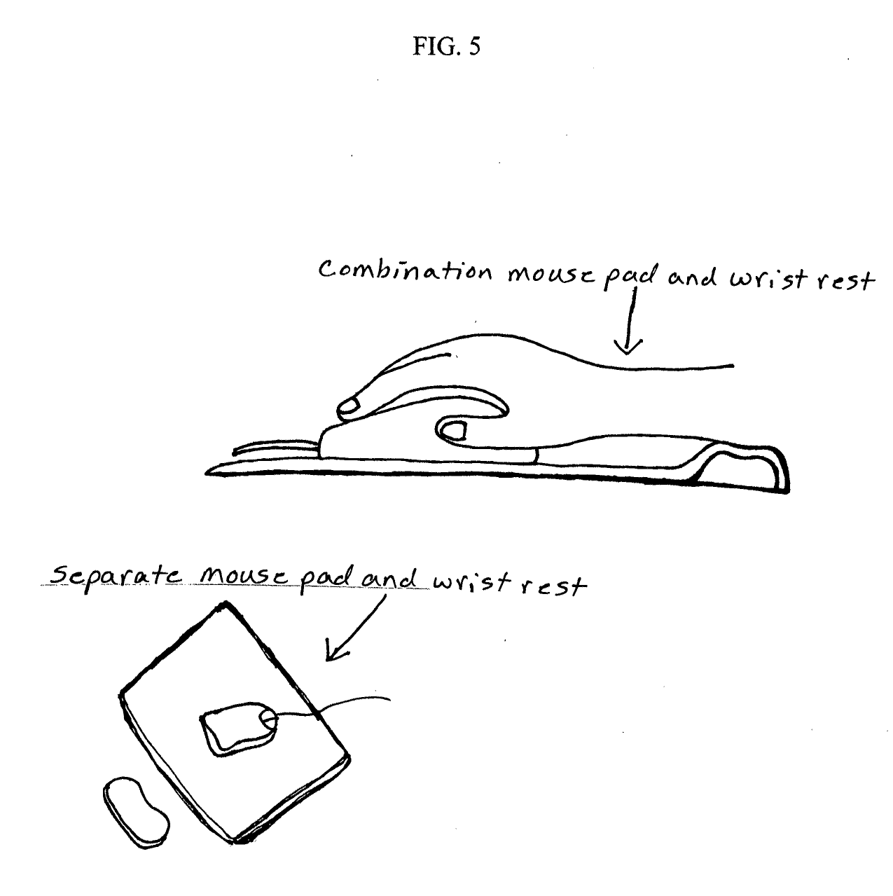

FIG. 5

### BACKGROUND OF THE INVENTION

The invention relates generally to the field of computer accessories particularly to wrist support. It moveably carries the user's mouse, wrist, in a manner that facilitates manual positioning of a computer mouse to position the cursor at a desired location.

Mouse pads, and wrist rests currently available require the user to keep the wrist directly on the wrist rest in order to maintain proper wrist support and alignment while at the same time keeping the mouse on a mouse pad. This severely limits the range of motion possible before wrist support is lost, causing stress on the median nerve and the risk a (RMI) repetitive motion injury will occur. Users often complain the mouse falls off the small mouse pad, surface area interrupting their work to stop, pick the mouse up, and put it back on the mouse pad.

### BRIEF SUMMARY OF THE INVENTION

A mouse pad and wrist support designed to connect a computer mouse and wrist rest so they move as one ergonomic unit. The invention solves the problems with current wrist support and mouse pad units and systems by: 1) Providing continuous proper wrist support and alignment at all times regardless of the direction or distance the mouse is moved. 2) Continuous wrist support allows the hand and wrist to remain relaxed and comfortable while eliminating stress on the median nerve; greatly reducing the risk of a (RMI) repetitive motion injury, such as, carpal tunnel syndrome from using a computer mouse. 3) Allows freedom of movement in every direction and distance because the range of motion limiting mouse pad is eliminated. (4) Eliminates work interruptions caused when the mouse falls off the mouse pad: stop, pick the mouse up, place it back on the mouse pad, restart work.

### BRIEF DESCRIPTION OF SEVERAL VIEWS OF THE DRAWING

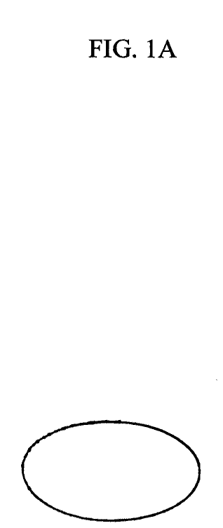

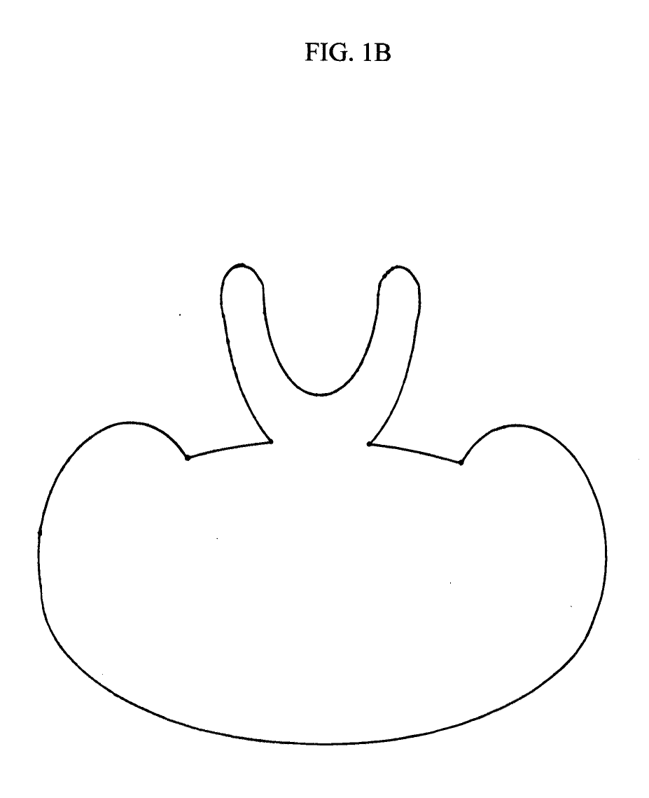

Drawing 1, FIG. 1A, the glide strip

Drawing 2, FIG. 1B, the chassis

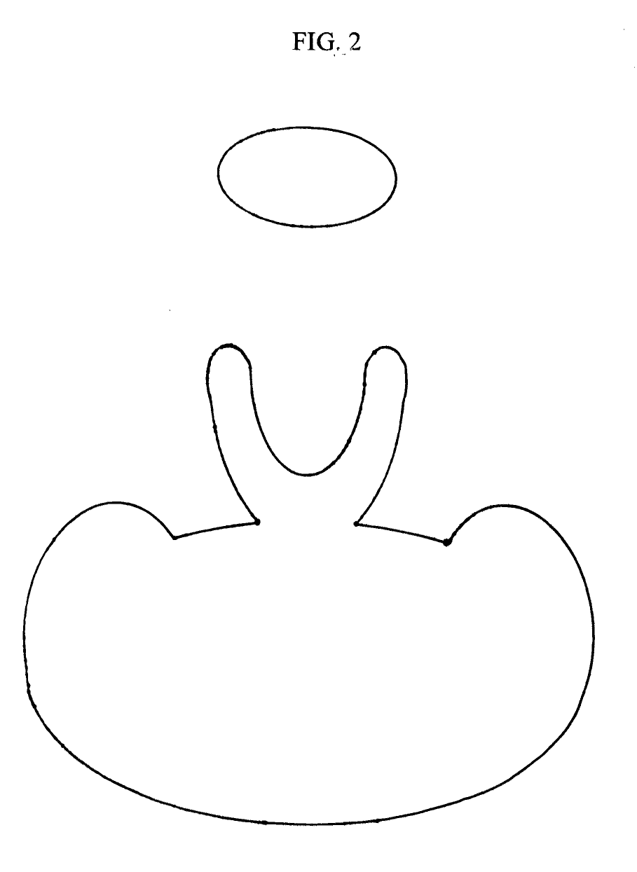

Drawing 3, FIG. 2, the invention, comprising the glide strip FIG. 1A, and the chassis, FIG. 1B, without measurements

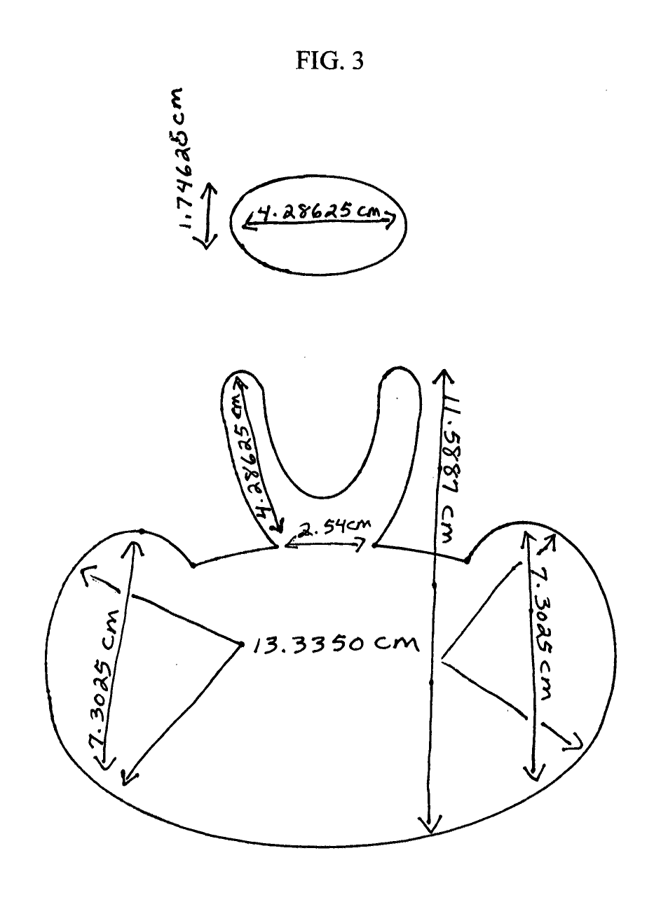

Drawing 4, FIG. 3 the invention, comprising the glide strip FIG. 1A, and the chassis, FIG. 1B, with measurements

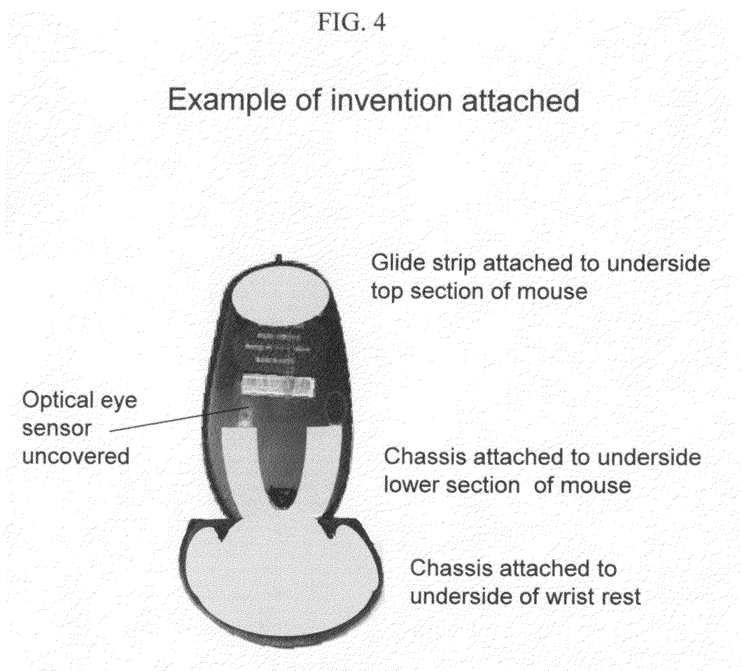

Illustration 1, FIG. 4 example invention affixed to the mouse and wrist rest

Drawing 5, FIG. 5, prior art of stationary mouse pad and wrist rest currently available and the gap problem that allows the wrist to sag, twist, and turn creating risk of RMI injuries.

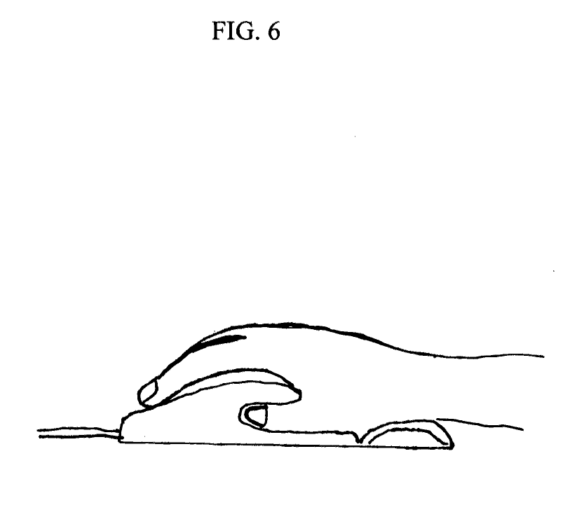

Drawing 6, FIG. 6, example of invention attached (which is not visible) that shows there is no gap between the mouse and wrist rest and it provides proper support and alignment because it is one moveable unit.

### DETAILED DESCRIPTION OF THE INVENTION

A mouse pad and wrist support for operating a pointing device commonly called a computer mouse on a surface, such as a table or desktop. Comprising: a flat glide strip universal to fit all mice and a flat chassis configured to be wrist rest type specific: Standard, kidney, straight, and ergobead. Drawings illustrate the chassis for a standard gel wrist rest design.

The invention is made of slick, smooth, non-abrasive polyethylene plastic with acrylic adhesive on one side, and cut by a die cutting machine. Colors available are black and neutral.

### Problems with Current Wrist Support Products and Systems

Current wrist support and mouse pad products and systems require (1) a separate mouse pad and wrist rest both of which remain stationary, FIG. 6, or (2) a combined mouse pad and wrist rest unit, FIG. 6, that also remains stationary. In order for these products and systems to provide proper wrist support and alignment the wrist must stay directly on the wrist rest.

It is very difficult and some say virtually impossible to keep the wrist directly on the wrist rest while maneuvering the mouse forward, backward, laterally, and diagonally. When moving the mouse forward the wrist extends off the wrist rest creating a gap between the mouse and wrist rest that allows the wrist to sag into the gap. This leaves the wrist unsupported and out of proper alignment FIG. 5.

When moving the mouse laterally or diagonally, the user most often tends to twist and turn the wrist to move the mouse in that direction which creates stress on the median nerve.

Sagging, twisting and turning of the wrist causes stress on the hand, wrist, and median nerve resulting in greater risk a (RMI) repetitive motion injury will occur.

### Invention Solution

The inventions foundation is a simple glide strip and flat chassis that affixes to a mouse and wrist rest by acrylic adhesive that allows the mouse and wrist rest to move as one unit. The invention provides continuous proper wrist support and alignment at all time.

The invention utilizes an ergonomic mouse already patented and sold in stores or included with a computer when purchased and a wrist rest already patented and sold in stores. By utilizing these ergonomic items the invention is ergonomic.

The invention greatly reduces the risk of a (RMI) repetitive motion injury because the wrist cannot extend off the wrist rest or out of proper support or alignment. Gaps between the mouse and wrist rest are eliminated which prevents the wrist from sagging, FIG. 6.

The invention allows the user to move the mouse and wrist rest laterally and diagonally without twisting and turning the wrist, further reducing the risk of a (RMI) repetitive motion injury.

The invention eliminates the need for a separate mouse pad which eliminates the range of motion restrictions in all directions forward, backward, laterally, and diagonally.

The invention eliminates work interruptions to stop, pick the mouse up and place it back on the mouse pad because the mouse is connected to the mouse pad.

The invention works with all wired and some wireless mice and has multiple chassis designs to fit specific wrist rest types.

### To Use the Invention

To use the assembled invention gently grip a mouse as you normally would. Lightly lay your wrist straight back on the wrist rest for proper wrist support and alignment, FIG. 6. To move the mouse forward or backward simply extend or retract the forearm. To move the mouse laterally or diagonally, simply slide the invention in the desired direction. The invention is not heavy and glides across a smooth surface, such as, a desktop with a just a light sliding motion of the hand and forearm.

### Invention Design Description

The glide strip is configured to affix to the underside top section of the mouse by acrylic adhesive. The glide strip is oval shaped, 0.0381 cm thick, 4.28625 cm wide×1.74625 cm high.

The chassis is one piece, comprising the mouse section and wrist rest section. The chassis is configured to affix to the underside lower section of a mouse and underside of a wrist rest by acrylic adhesive.

The mouse section is the U shaped upper section of the chassis, 0.0381 cm thick, and measures 4.7625 cm wide×4.28625 cm high.

Height from the top of mouse section to bottom of the wrist rest section 11.5887 cm. Width at the base of the mouse section that connects to the wrist rest section 2.54 cm.

The wrist rest section is the lower section of the chassis, 0.0381 cm thick, and measures 13.3350 cm wide×7.3025 cm high.

### Invention Assembly

When the invention is attached, the mouse and wrist rest turned over for use the invention is not visible.

Glide strip—peel the protective cover off the back off the glide strip exposing the adhesive. Align the glide strip over the top underside section of a mouse. Press entire piece firmly in place.

Chassis—peel the protective cover off the back of the chassis exposing the adhesive. Align the underside of the wrist rest over the wrist rest section, lower section of the chassis. Make sure the U shaped mouse section is centered in the curvature of the wrist rest.

Mouse—align the bottom underside, lower section of the mouse over the mouse section of the chassis, the U shaped upper section of the chassis. Make sure the mouse is centered in the curvature of the wrist rest and the mouse and wrist rest meet. Press firmly in place.

### DRAWINGS

Five drawings are included: FIGS. 1A 1B 1A & 1B 2 3 5 6

One illustration is included: FIG. 4

### Oath or Declaration

0 Form PTO/SB01 included in application packet

### Sequence Listing

Not applicable

What is claimed is: By connecting a computer mouse and wrist rest into one ergonomic moveable unit that allows freedom of movement without the wrist sagging, twisting, and turning, stress on the hand, wrist, and median nerve are eliminated reducing the risk a (RMI) repetitive motion injury will occur from using a computer mouse.

1. The wrist support of claim 1, comprises two pieces, a glide strip and chassis configured to affix to the mouse and wrist rest by acrylic adhesive.

2. The glide strip is oval shaped and is configured to attach to the underside top section of the mouse.

3. The chassis's upper section is U shaped and is configured to affix to the underside lower section of a mouse. The chassis's lower section is configured to affix to the underside of a wrist rest.

4. The chassis's U shaped upper section is universal to fit all wired and some wireless mice. The chassis's lower section is designed to be wrist rest specific, standard, kidney, straight, ergobead.
